(19) United States
(12) Patent Application Publication
(10) Pub. No.: US 2014/0363188 A1
(43) Pub. Date: Dec. 11, 2014

(54) IMAGE FORMING APPARATUS

(71) Applicant: Sharp Kabushiki Kaisha, Osaka (JP)

(72) Inventor: Hirotsugu Akamatsu, Osaka (JP)

(73) Assignee: Sharp Kabushiki Kaisha, Osaka (JP)

(21) Appl. No.: 14/370,573

(22) PCT Filed: Dec. 27, 2012
(86) PCT No.: PCT/JP2012/083797

§ 371 Date: Jul. 3, 2014

(30) Foreign Application Priority Data
Jan. 5, 2012 (JP) 2012-000319

(51) Int. Cl. G03G 15/00

(52) U.S. Cl. CPC G03G 15/5004; H04N 1/00904; H04N 1/00907; H04N 1/00925; H04N 1/00915; H04N 1/0057; H04N 2201/0094
USPC 399/88

(57) ABSTRACT

An image forming apparatus includes two power cords (70, 80), a plurality of processing sections, a relay (91) and a control section (87). The relay (91) is switched between a conducting state where the two power cords (70, 80) can provide a bilateral supply of power between each other and a cut-off state where they cannot. The control section (87) stores an order of priority for the plurality of processing sections, switches the relay (91) from the cut-off state to the conducting state when a supply of power through either one power cord of the two power cords (70, 80) is cut off, and, by selecting a processing section sequentially according to the order of priority, causes load instruments included in the processing section currently selected to be driven while causing load instruments other than specified load instruments among load instruments included in processing sections currently not selected to stop.

### TECHNICAL FIELD

The present invention relates to an image forming apparatus to which an electric power is supplied by way of two power cords.

### BACKGROUND ART

In recent years, with a growing demand for the speedup of an image forming process in an image forming apparatus using the electrophotography process such as copier, printer, facsimile, and multifunctional apparatus that is made up of their combinations or the like, wattage of a fixing heater and wattage of a motor that are installed in the image forming apparatus have been increasing; and thus there has been a tendency for the power consumption of the image forming apparatus to increase. Additionally, the change to color and/or high accuracy processing in the image forming apparatus has also resulted in the increase of high voltage loads and motor loads, thereby having further added to its power consumption.

By the way, due to regulations on the ratings of sockets for the AC power source which is the common power source for the image forming apparatus, it is necessary for the image forming apparatus to be used at values not greater than the rated values. Because a maximum value for every typically usable power source in ordinary offices in Japan is 1,500 W, when an AC power input is taken from a common socket of 100V using a single power cord, the electric current is limited to a value not greater than 15 A. Therefore, when an electric power of not less than 1,500 W is needed, construction of a special power source becomes necessary.

Thus, an image forming apparatus to which an electric power is supplied by way of a plurality of power cords has become known (for example, refer to Patent Literature 1). This conventional image forming apparatus is configured in such a manner as to be capable of supplying the electric power to both load systems even when one power cord of the two power cords comes off.

### CITATION LIST

### Patent Literature

Patent Literature 1: Japanese Patent Unexamined Publication No. 2007-316245 bulletin

### SUMMARY OF INVENTION

### Technical Problem

However, the Patent Literature 1 does not contain a description of concrete control procedures on when the supply of the power by way of either one power cord of the two power cords is cut off. Therefore, in the conventional image forming apparatus, although the power supplied to the image forming apparatus decreases when the supply of the power by way of either one power cord of the two power cords is cut off, it is not clear about how each of load instruments can be driven. Thus, in the conventional image forming apparatus, if the supply of the power by way of either one power cord of the two power cords is cut off, there is a risk that major damages occur such as scattering of unfixed toner due to a halt of the fixing process, paper jam due to a halt of the paper conveyance and/or the like. If a major damage occurs, a quick recovery becomes a difficult matter.

The present invention is directed to providing an image forming apparatus capable of suppressing damages even when a supply of a power by way of either one power cord of two power cords is cut off.

### Solution to Problem

An image forming apparatus of the present invention includes two power cords, a plurality of processing sections, an input detecting section, a switching section and a control section. The power cords are each connected to a power source. The processing sections each include one or more load instruments to which an electric power is supplied by way of either of the two power cords. The input detecting section outputs signals that depend on whether or not an electric power supplied by way of each of the two power cords exists. The switching section is switched between a conducting state in which the two power cords are permitted to provide a bilateral supply of power between each other and a cut-off state in which the two power cords are not permitted to provide the bilateral supply of power between each other. The control section stores a preset order of priority for the plurality of processing sections, and upon determining, based on a signal inputted from the input detecting section, that an electric power cutoff situation in which the supply of the power by way of either one power cord of the two power cords is cut off occurred, switches the switching section from the cut-off state to the conducting state; and, by selecting a processing section sequentially according to the order of priority, causes the load instruments that are included in the processing section currently selected to be driven while causing load instruments other than a specified load instrument among load instruments that are included in processing sections currently not selected to stop.

With the configuration, the switching section is switched to the conducting state if the electric power cutoff situation occurs, and thereby the electric power is supplied from the power cord by way of which the supply of the power is not cut off to the load systems to which the supply of the power is cut off. Also, because the load instruments that are included in the processing section that is currently selected according to the order of priority among the plurality of processing sections are caused to be driven while the load instruments other than the specified load instrument among the load instruments that are included in the processing sections that are not currently selected are caused to stop, a number of the load instruments that are driven at the same time decreases, and thereby power consumption decreases. As a result, even when the electric power cutoff situation occurs and thereby the power supplied to the image forming apparatus decreases, it is possible to surely drive the load instruments that are included in the processing section currently selected. Moreover, because the processing sections are each selected sequentially, wherever paper sheets are in any of the processing sections at the time when the electric power cutoff situation occurs, the paper sheets can be discharged sequentially from all the processing sections.

### Advantageous Effects of Invention

The present invention makes it possible to suppress damages even when a supply of a power by way of either one power cord of two power cords is cut off.

### BRIEF DESCRIPTION OF DRAWINGS

FIG. 1 is a drawing showing a general configuration of an image forming apparatus according to an embodiment of the present invention.

FIG. 2 is a block diagram of a power source system of the image forming apparatus.

FIG. 3 is a flow chart showing a part of procedures by a control section.

FIG. 4 is a flow chart showing another part of procedures by the control section.

### DESCRIPTION OF EMBODIMENTS

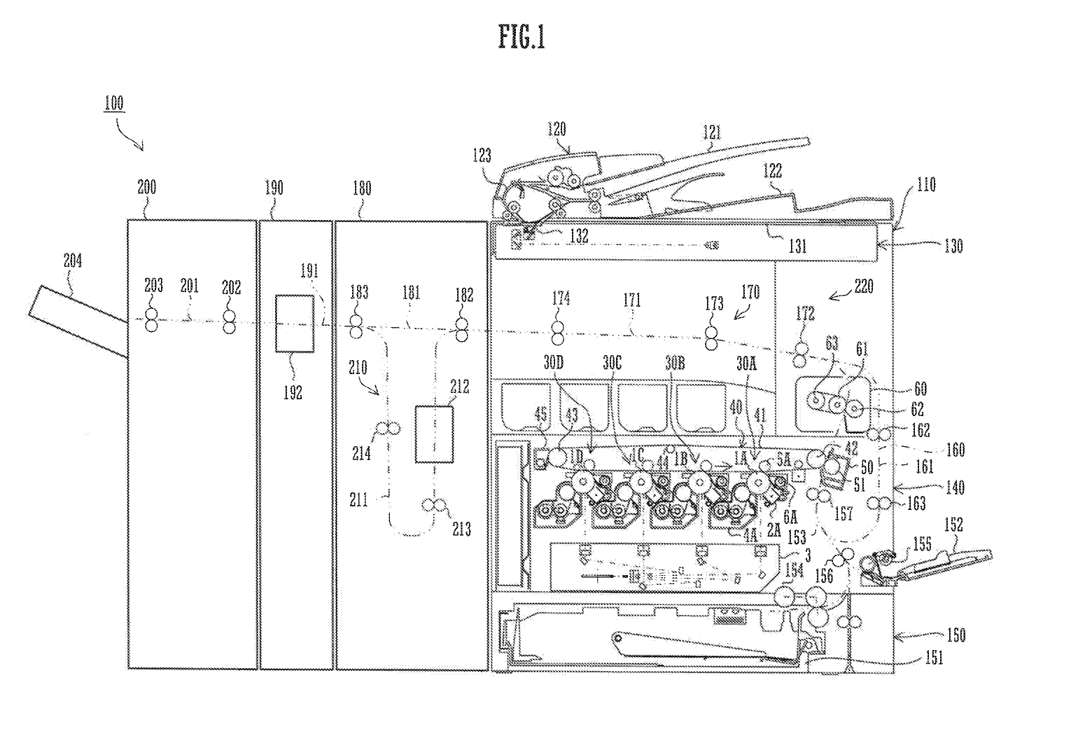

An embodiment of the present invention is explained below, referring to the drawings. As shown in FIG. 1, an image forming apparatus 100 includes a main body 110, an automatic document feeder (ADF) 120, and post-processing devices which are a clear coat device 180, a punch staple device 190, and a finisher 200. The image forming apparatus 100 forms a multicolored or monochromatic image onto a paper sheet based on image data produced from a document or image data output from outside. For the paper sheet, a sheet-like recording medium such as normal paper, photographic paper, OHP film or the like can be exemplified.

The ADF 120 is disposed on the main body 110, and is configured in such a manner that its edge portion on the front face's side can be swung in upward and downward directions with its edge portion on the rear face's side being supported at its shaft by the main body 110.

The main body 110 includes an image reading section 130, an image forming section 140, a paper feeding section 150, a secondary conveying section 160 and a transit path unit 170.

The image reading section 130 is disposed in an upper part of the main body 110, and its top surface includes a first document table 131 and a second document table 132. The top surfaces of the first document table 131 and the second document table 132 can be opened and closed by the ADF 120. In fixed document reading mode, the image reading section 130 reads an image of the document placed on the first document table 131, and produces image data. Also, in conveyed document reading mode, the ADF 120 conveys the documents received in a document load tray 121 piece by piece to a document receiving tray 122 through the top surface of the second document table 132; and then the image reading section 130 reads an image of the document conveyed through the top surface of the second document table 132, thereby producing image data.

The image forming section 140 includes an optical scanner 3, four image forming stations 30A, 30B, 30C, 30D, an intermediate transfer unit 40, a secondary transfer unit 50 and a fuser unit 60, and performs an image forming process onto a paper sheet.

The intermediate transfer unit 40 includes an intermediate transfer belt 41, a drive roller 42, an idle roller 43 and a tension roller 44. The intermediate transfer belt 41 is passed over the drive roller 42, the idle roller 43 and the tension roller 44 and tensioned therewith, thereby forming a loop-like path of movement.

The image forming section 140 forms, at the image forming stations 30A through 30D, toner images of respective hues of four colors consisting of black, as well as cyan, magenta, and yellow which are the three primary colors of the subtractive color mixture obtained from the color separation of a color image. The image forming stations 30A through 30D are aligned along the path of movement of the intermediate transfer belt 41. The image forming stations 30B through 30D are configured substantially in the same manner as the image forming station 30A.

The image forming station 30A for black includes a photoreceptor drum 1A, an electrostatic charger 2A, a developing device 4A, a primary transfer roller 5A and a cleaning unit 6A.

The photoreceptor drum 1A rotates in a predetermined direction with a driving force thereto transmitted from a driving source not illustrated. The electrostatic charger 2A causes a circumferential surface of the photoreceptor drum 1A to be charged to a predetermined electrostatic potential.

The optical scanner 10 projects respective laser beams modulated by image data on the respective hues consisting of black, cyan, magenta and yellow onto the respective photoreceptor drums 1A, 1B, 1C, 1D of the image forming stations 30A through 30D. On the circumferential surfaces of the photoreceptor drums 1A through 1D are respectively formed electrostatic latent images based on the image data on the respective hues consisting of black, cyan, magenta and yellow.

The developing device 4A supplies a black toner which is the hue for the image forming station 30A to the circumferential surface of the photoreceptor drum 1A, thereby rendering the electrostatic latent image visible in a black toner image.

An outer peripheral surface of the intermediate transfer belt 41 sequentially faces the circumferential surfaces of the photoreceptor drums 1A through 1D. The primary transfer roller 5A is disposed at a position opposite the photoreceptor drum 1A sandwiching the intermediate transfer belt 41 in between. Respective positions at which the intermediate transfer belt 41 and each of the photoreceptor drums 1A through 1D face one another are positions where primary transfers are performed.

To the primary transfer roller 5A, a primary transfer bias of a polarity (for example, plus) reverse to an electrostatic charge polarity (for example, minus) of the toner is applied with a constant voltage control. The same applies to the image forming stations 30B through 30D. This causes the toner images of respective hues having been formed on the respective circumferential surfaces of the photoreceptor drums 1A through 1D to undergo primary transfers sequentially in such a manner as to be superimposed onto the outer peripheral surfaces of the intermediate transfer belt 41, thereby causing a full-color toner image to be formed on the outer peripheral surface of the intermediate transfer belt 41.

However, when image data on only part of the hues consisting of black, cyan, magenta and yellow are inputted, electrostatic latent image(s) and toner image(s) are formed only at part of the drum(s) corresponding to the part of the hues of the inputted image data among the four photoreceptor drums 1A through 1D, and thus only the toner image(s) of the part of the hues undergoes primary transfer(s) onto the outer peripheral surface of the intermediate transfer belt 41.

The cleaning unit 6A collects the toner remaining on the circumferential surface of the photoreceptor drum 1A after the primary transfer.

The toner images that have undergone the primary transfers onto the outer peripheral surface of the intermediate transfer belt 41 are conveyed by the rotating intermediate transfer belt 41 to a secondary transfer position at which the intermediate transfer belt 41 and a secondary transfer roller 51 that is installed in the secondary transfer unit 50 face each other.

The paper feeding section 150 includes a paper feed cassette 151, a hand-fed paper tray 152, a primary conveying path 153, pickup rollers 154, 155, a conveyance roller 156 and a paper stop roller 157.

In the paper feed cassette 151 are received paper sheets of size and kind with a relatively high frequency in use. The paper sheets received in the paper feed cassette 151 are fed by the pickup roller 154, and then supplied to the primary conveying path 153 piece by piece.

Onto the hand-fed paper tray 152 are placed paper sheets of size and kind with a relatively low frequency in use. The paper sheets placed onto the hand-fed paper tray 82 are fed by the pickup roller 155, and then supplied to the primary conveying path 153 piece by piece.

The primary conveying path 153 is configured so as to reach a third conveying path 171 of the transit path unit 170 from each of the paper feed cassette 151 and the hand-fed paper tray 152 through the secondary transfer position and the fuser unit 60.

The secondary conveying section 160 includes a secondary conveying path 161 and a plurality of conveyance rollers 162, 163. The secondary conveying path 161, which is a paper conveying path for duplex image forming, is configured in such a manner that a paper sheet on one side of which an image forming has been performed is conveyed, with its both sides turned, again to the secondary transfer position. The plurality of conveyance rollers 162, 163 are installed along the secondary conveying path 161, and convey the paper sheet in the secondary conveying path 161.

The secondary transfer roller 51 is in contact with the drive roller 42 with a predetermined nip pressure sandwiching the intermediate transfer belt 41 in between.

When the paper sheet fed from the paper feeding section 150 is conveyed through the secondary transfer position, a secondary transfer bias of a polarity (for example, plus) reverse to an electrostatic charge polarity (for example, minus) of the toner is applied to the secondary transfer roller 51 with a constant voltage control; and this causes the toner image borne on the outer peripheral surface of the intermediate transfer belt 41 to undergo a secondary transfer onto the paper sheet.

The toner remaining on the intermediate transfer belt 41 after the toner image has been transferred onto the paper sheet is collected by an intermediate transfer belt cleaning unit 45.

The paper sheet onto which the toner image has been transferred is led to the fuser unit 60. The fuser unit 60, being provided with a heating roller 61 and a pressing roller 62, heats and presses the paper sheet that is passing between the heating roller 61 and the pressing roller 62, thereby fixing the toner image on the paper sheet. The paper sheet on which the toner image has been fixed is sent to the transit path unit 170.

The transit path unit 170 includes a plurality of conveyance rollers 172, 173, 174, in addition to the third conveying path 171. The third conveying path 171 connects to the primary conveying path 153, and is formed in such a manner that the paper sheet conveyed passing through the primary conveying path 153 is discharged to a side face of the main body 110. The plurality of conveyance rollers 172, 173, and 174 are installed along the third conveying path 171, and convey the paper sheet in the third conveying path 171.

The clear coat device 180 includes a fourth conveying path 181, conveyance rollers 182, 183 and a clear coat processing section 210. The fourth conveying path 181 connects to the third conveying path 171. The conveyance rollers 182, 183 are installed along the fourth conveying path 181, and convey the paper sheet.

The clear coat processing section 210 includes a clear coat conveying path 211, a clear coat processing unit 212, and conveyance rollers 213, 214. The clear coat conveying path 211 is formed in such a manner as to branch off from the fourth conveying path 181 and to join the fourth conveying path 181 on the downstream side from the branching-off point. The clear coat processing unit 212 and the conveyance rollers 213, 214 are installed in the clear coat conveying path 211. The clear coat processing unit 212 applies a clear coat process to the paper sheet onto which an image has been formed. The conveyance rollers 213, 214 convey the paper sheet in the clear coat conveying path 211.

The punch staple device 190 includes a fifth conveying path 191, and a punch staple processing unit 192. The fifth conveying path 191 connects to the fourth conveying path 181. The punch staple processing unit 192 applies a punch process and a staple process to the paper sheet.

The finisher 200 includes a sixth conveying path 201, conveyance rollers 202, 203, and a paper discharge tray 204. The sixth conveying path 201 connects to the fifth conveying path 191. The conveyance rollers 202, 203, are installed along the sixth conveying path 201, and convey the paper sheet in the sixth conveying path 201. The finisher 200 has a sort processing function and an offset processing function to the paper sheet.

The transit path unit 170, the fourth conveying path 181, the conveyance rollers 182, 183, the fifth conveying path 191, the sixth conveying path 201, and the conveyance rollers 202, 203 are included in a paper discharge processing section 220. The paper sheet that has passed through the paper discharge processing section 220 is discharged to the paper discharge tray 204.

The image forming section 140, the paper feeding section 150, the secondary conveying section 160, the paper discharge processing section 220 and the clear coat processing section 210 each constitute a processing section that includes one or more load instruments. Each processing section includes a paper sheet detecting section not illustrated that detects whether or not there is a paper sheet in the processing section.

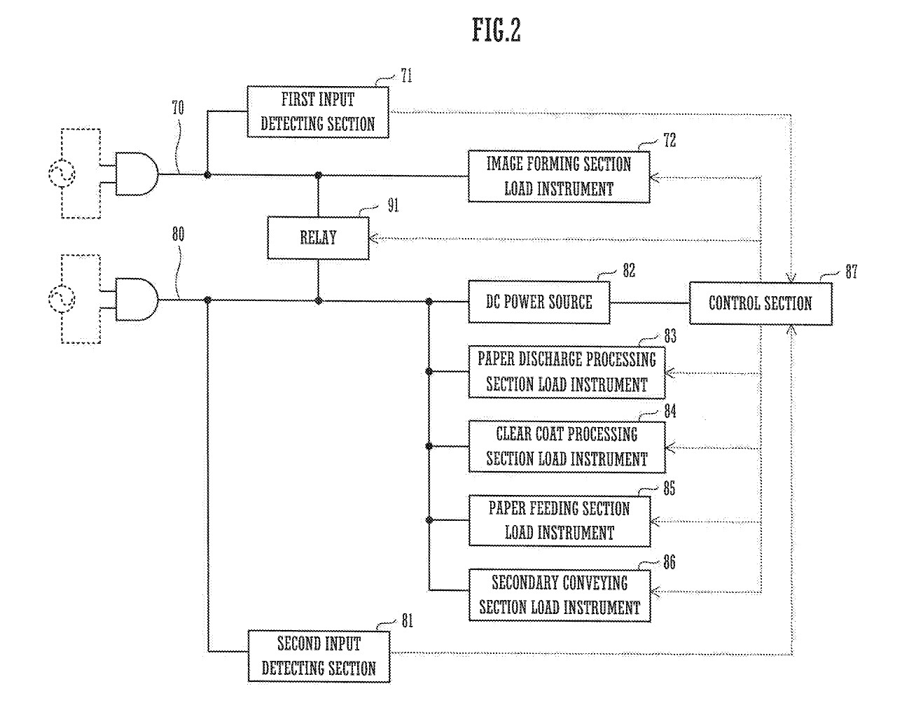

As shown in FIG. 2, to the image forming apparatus 100 an alternating-current electric power (hereinafter referred to as AC power) is supplied from an alternating-current power source (hereinafter referred to as AC power source) by way of two power cords 70, 80 each.

To the first power cord 70, a first input detecting section and an image forming section load instrument 72 are connected. The first input detecting section 71 outputs signals that depend on whether or not the power supplied by way of the first power cord 70 exists. As an example, the first input detecting section 71 outputs, to the control section 87, a zero cross signal of the AC power that is supplied by way of the first power cord 70. The control section 87 determines that the supply of the AC power by way of the first power cord 70 was cut off if an interval of the zero cross signal that is inputted from the first input detecting section 71 becomes longer than a predetermined period of time.

To the second power cord 80, a second input detecting section 81, a direct current power source (hereinafter referred to as DC power source) 82, a paper discharge processing section load instrument 83, a clear coat processing section load instrument 84, a paper feeding section load instrument 85, and a secondary conveying section load instrument 86 are connected. The second input detecting section 81 outputs signals that depend on whether or not the power supplied by way of the second power cord 80 exists. As an example, the second input detecting section 81 outputs, to the control section 87, a zero cross signal of the AC power that is supplied by way of the second power cord 80. The control section 87 determines that the supply of the AC power by way of the second power cord 80 was cut off if an interval of the zero cross signal that is inputted from the second input detecting section 81 becomes longer than a predetermined period of time.

To the DC power source 82, the control section 87 is connected. The DC power source 82 converts the AC power from the AC power source into a DC power, which is supplied to the control section 87. The control section 87 exercises general control over the load instruments of the respective sections of the image forming apparatus 100.

The image forming section load instrument 72 includes a drive motor, the electrostatic charger 2A, the optical scanner 3, the primary transfer roller 5A, the secondary transfer roller 51, and a fixing heater 63 (refer to FIG. 1). The drive motor supplies a turning force to the photoreceptor drum 1A, the developing device 4A, the drive roller 42 and the fuser roller 61. The fixing heater 63 heats a circumferential surface of the fuser roller 61.

The paper discharge processing section load instrument 83 includes a drive motor supplying a turning force to the conveyance rollers 172, 173, 174, 182, 183, 202, 203.

The clear coat processing section load instrument 84 includes a drive motor supplying a turning force to the clear coat processing unit 212 and the conveyance rollers 213, 214.

The paper feeding section load instrument 85 includes a drive motor supplying a turning force to the pickup rollers 154, 155, the conveyance roller 156, and the paper stop roller 157, and a clutch.

The secondary conveying section load instrument 86 includes a drive motor supplying a turning force to the conveyance rollers 162, 163.

The image forming apparatus 100 further includes a relay 91. The relay 91 is an example of a switching section that is switched between a conducting state in which the two power cords 70, 80 are permitted to provide a bilateral supply of power between each other and a cut-off state in which the two power cords are not permitted to provide the bilateral supply of power between each other.

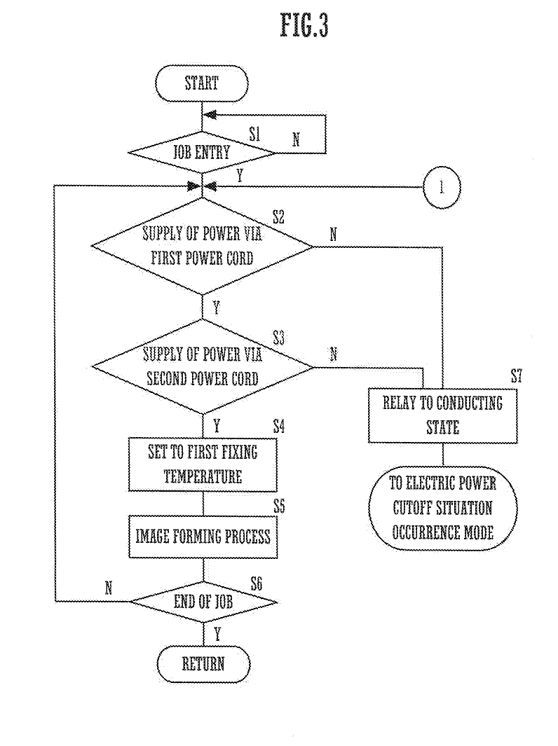

As shown in FIG. 3, when a print job entry is made (S1), the control section 87, based on the signal inputted from the first input detecting section 71, determines whether or not the supply of the power by way of the first power cord 70 is carried out (S2). If the supply of the power by way of the first power cord 70 is carried out, the control section 87, based on the signal inputted from the second input detecting section 81, determines whether or not the supply of the power by way of the second power cord 80 is carried out (S3).

If both supplies of the powers by way of the first power cord 70 and by way of the second power cord 80 are carried out, the control section 87, by setting a set-temperature of the fuser roller 61 to a normal fixing temperature and then carrying out a fixing temperature control of the fixing heater 63 (S4), performs an image forming process (S5). The normal fixing temperature is a temperature at which the toner image is durably stuck on the paper sheet. If the print job is not completed, the control section 87 returns to the process of S2 and continues the print job; and when the print job is completed, the control section 87 waits for a next printing job entry (S6).

In the processes of S2 and S3, the control section 87, upon determining, based on the signals inputted from the first input detecting section 71 and the second input detecting section 81, that an electric power cutoff situation in which the supply of the power by way of either one power cord of the two power cords 70, 80 is cut off occurred, switches the relay 91 from the cut-off state to the conducting state, thereby switching over to an electric power cutoff situation occurrence mode.

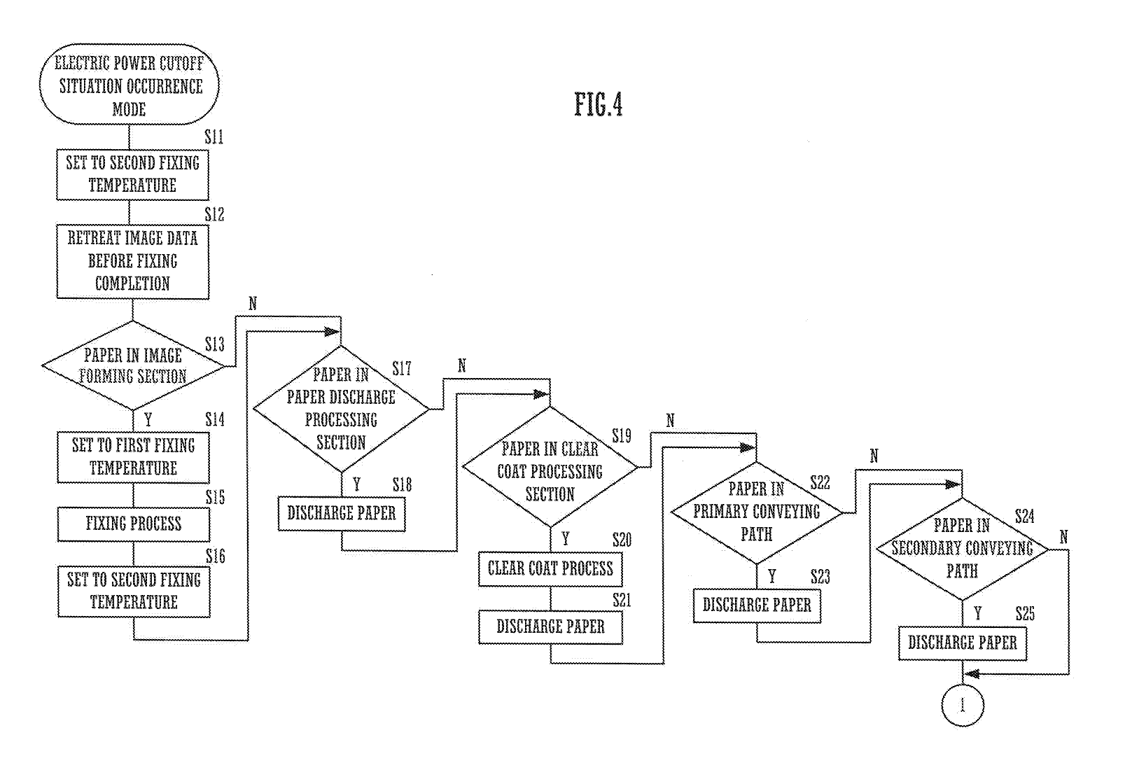

As shown in FIG. 4, the control section 87, upon switching over to the electric power cutoff situation occurrence mode, sets the fixing process temperature to a second fixing temperature and therewith controls the fixing heater 63 (S11), and causes image data of which fixing process by the fuser unit 60 has not been completed to retreat into a memory section that is included in the control section 87 (S12). Besides, the control section 87 brings formation of a new toner image in the image forming section 140 to a halt. Bringing the formation of the new toner image to a halt prevents unfixed toner from being borne on the paper sheet, thereby suppressing scattering of the unfixed toner.

The control section 87 stores a preset order of priority for the processing sections such as, for example, the image forming section 140, the paper feeding section 150, the secondary conveying section 160, the paper discharge processing section 220, and the clear coat processing section 210. As an example, the order of priority is set, from the highest, in order of the image forming section 140, the paper discharge processing section 220, the clear coat processing section 210, the paper feeding section 150, and the secondary conveying section 160.

The control section 87, upon determining that the electric power cutoff situation occurred, selects sequentially each of the processing sections 140, 150, 160, 210, 220 according to the order of priority, and causes the load instruments that are included in the processing section currently selected to be driven while causing load instruments other than a specified load instrument among load instruments that are included in processing sections currently not selected to stop.

Then, if the paper sheet detecting section does not detect a paper sheet in the processing section that is currently selected, the control section 87, without causing the load instruments other than the specified load instrument among the load instruments included in the processing section that is currently selected to be driven, selects a next processing section.

Specifically, the control section 87 first selects the image forming section 140 for which the order of priority is the highest, and if there is a paper sheet in the image forming section 140 (S13), by setting the fixing process temperature to a first fixing temperature and therewith controlling the fixing heater 63 (S14), carries out a fixing process (S15). The first fixing temperature is a predetermined temperature that is lower than the normal fixing temperature and higher than the second fixing temperature. With the fixing temperature being set at the first fixing process temperature while the image forming section 140 is selected, unfixed toner is compressed and bonded thermally on the paper sheet at least to such an extent that it is not scattered therefrom.

When the fixing process is completed, the control section 87 sets the fixing temperature to the second fixing process temperature (S16), and then selects the paper discharge processing section 220 for which the order of priority is next to the highest. With the fixing temperature being set to the second fixing process temperature while a processing section other than the image forming section 140 is selected, power consumption decreases, and occurrence of transferred stains which means that the toner sticking to the members such as the fuser roller 61, the pressing roller 62 and/or the like is unavoidably transferred onto the paper sheet in the secondary transfer position when the paper sheet passes through the secondary transfer position from the upstream side to the downstream side in a direction of conveyance of the paper sheet is suppressed.

The control section 87, if it determines that there is no paper sheet in the image forming section 140 in the process of S13, without causing the load instruments other than the fixing heater 63 among the load instruments included in the image forming section 140 to be driven, selects the paper discharge processing section 220 for which the order of priority is next to the highest. In the embodiment, the fixing heater 63 is a specified load instrument. Selecting the next processing section without causing the load instruments other than the specified load instrument to be driven in the processing section where there is no paper sheet makes it possible to discharge paper sheets from all the processing sections quickly.

The control section 87, upon selecting the paper discharge processing section 220, detects whether or not there is a paper sheet in the paper discharge processing section 220 (S17), and if there is a paper sheet in the paper discharge processing section 220, causes the load instruments included in the paper discharge processing section 220 to be driven and thereby discharges the paper sheet from the paper discharge processing section 220 to the paper discharge tray 204 (S18), and then selects the clear coat processing section 210 for which the order of priority is next to the former.

The control section 87, upon selecting the clear coat processing section 210, detects whether or not there is a paper sheet in the clear coat processing section 210 (S19), and if there is a paper sheet in the clear coat processing section 210, performs a clear coat process (S20) and discharges the paper sheet from the clear coat processing section 210 (S21), and then selects the paper feeding section 150 for which the order of priority is next to the former.

The control section 87, upon selecting the paper feeding section 150, detects whether or not there is a paper sheet in the primary conveying path 153 (S22), and if there is a paper sheet in the primary conveying path 153, discharges the paper sheet from the primary conveying path 153 (S23), and then selects the secondary conveying section 160 for which the order of priority is next to the former.

The control section 87, upon selecting the secondary conveying section 160, detects whether or not there is a paper sheet in the secondary conveying path 161 (S24), and if there is a paper sheet in the secondary conveying path 161, discharges the paper sheet from the secondary conveying path 161 (S25), and then returns to the process of S2.

If the electric power cutoff situation still continues, the control section 87 selects again the image forming section 140 for which the order of priority is the highest. In this manner, since each of the processing sections is selected sequentially, even in the case where paper sheets exist in any processing sections at the time when the electric power cutoff situation occurs, the paper sheets can be discharged from all the processing sections sequentially. Therefore, paper jam caused by the occurrence of the electric power cutoff situation can be prevented.

With the image forming apparatus 100, if the electric power cutoff situation occurs, switching the relay 91 to the conducting state if the electric power cutoff situation occurs makes it possible to supply the electric power from the power cord by way of which the supply of the power is not cut off to the load systems to which the supply of the power is cut off. Moreover, because the load instruments that are included in the processing section currently selected according to the order of priority among the plurality of processing sections are caused to be driven while the load instruments other than the specified load instrument among the load instruments that are included in the processing sections not currently selected are caused to stop, a number of the load instruments that are driven at the same time decreases, and thereby power consumption can be reduced. As a result, even when the electric power cutoff situation occurs and thereby the power supplied to the image forming apparatus decreases, it is possible to surely drive the load instruments that are included in the processing section currently selected.

Therefore, even when the supply of the power by way of either one power cord of the two power cords 70, 80 is cut off, it is possible to suppress damages such as scattering of unfixed toner due to a halt of the fixing process and/or paper jam due to a halt of the paper conveyance.

Besides, giving first priority to driving the image forming section 140 when the power cutoff situation occurs makes it possible to further suppress scattering of the unfixed toner from the paper sheet.

Further, the control section 87 can be configured in such a manner as to decrease, upon determining that the electric power cutoff situation occurred, a paper conveyance speed provided by the load instruments that are included in the processing section currently selected. Because the power consumption is further reduced by decreasing the paper conveyance speed, it is possible to drive the load instruments that are included in the processing section currently selected more surely.

The above explanation of the embodiment is nothing more than illustrative in any respect, nor should be thought of as restrictive. Scope of the present invention is indicated by claims rather than the above embodiment. Further, it is intended that all changes that are equivalent to a claim in the sense and realm of the doctrine of equivalence be included within the scope of the present invention.

### REFERENCE SIGNS LIST

60 fuser unit
63 fixing heater
70 first power cord
71 first input detecting section
72 image forming section load instrument
80 second power cord
81 second input detecting section
83 paper discharge processing section load instrument
84 clear coat processing section load instrument
85 paper feeding section load instrument
86 secondary conveying section load instrument
87 control section
91 relay (switching section)
100 image forming apparatus
140 image forming section
150 paper feeding section
160 secondary conveying section
170 transit path unit
180 clear coat device
190 punch staple device
200 finisher
220 paper discharge processing section

1. An image forming apparatus comprising:
two power cords that are each connected to a power source;
a plurality of processing sections each of which includes one or more load instruments to which electric power is supplied by way of either of the two power cords;
an input detecting section outputting signals that depend on whether or not an electric power supplied by way of each of the two power cords exists;
a switching section that is switched between a conducting state in which the two power cords are permitted to provide a bilateral supply of power between each other and a cut-off state in which the two power cords are not permitted to provide the bilateral supply of power between each other; and
a control section that stores a preset order of priority for the plurality of processing sections and upon determining, based on a signal inputted from the input detecting section, that an electric power cutoff situation in which a supply of power by way of either one power cord of the two power cords is cut off occurs, switches the switching section from the cut-off state to the conducting state, and that, by selecting one or more processing sections among the processing sections sequentially according to the order of priority, causes the one or more load instruments that are included in the processing section currently selected to be driven while causing the one or more load instruments other than one or more specified load instruments among load instruments that are included in processing sections currently not selected to stop.

2. The image forming apparatus as claimed in claim 1, wherein the control section, upon determining that the electric power cutoff situation occurred, decreases a paper conveyance speed provided by the load instruments that are included in the processing section currently selected.

3. The image forming apparatus as claimed in claim 1 comprising an image forming section that carries out an image forming process according to the electrophotography method, the image forming section being one of the plurality of processing sections, wherein the order of priority for the image forming section is set highest among the plurality of processing sections.

4. The image forming apparatus as claimed in claim 3, wherein the control section, upon determining that the electric power cutoff situation occurred, brings formation of a new toner image in the image forming section 140 to a halt.

5. The image forming apparatus as claimed in claim 3, wherein
the image forming section includes a fixing heater which is the one or more specified load instruments; and
the control section, upon determining that the electric power cutoff situation occurs, controls the fixing heater by setting a fixing process temperature at a first fixing temperature while the image forming section is selected, and by setting the fixing process temperature at a second fixing temperature that is lower than the first fixing temperature while a processing section other than the image forming section is selected.

6. The image forming apparatus as claimed in claim 1 further comprising a paper detecting section in each of the plurality of processing sections that detects therein whether or not there is a paper sheet, wherein if the paper sheet detecting section does not detect a paper sheet in the processing section that is currently selected, the control section, without causing the one or more load instruments other than the one or more specified load instruments among the load instruments included in the processing section that is currently selected to be driven, selects a next processing section.
